(19) United States
(12) Patent Application Publication
(10) Pub. No.: US 2006/0101909 A1
(43) Pub. Date: May 18, 2006

(54) Angular rate sensor with temperature compensation and vibration compensation

(76) Inventors: Yuan Lo, Taoyuan County (TW); Lung-Yung Lin, Hsinchu City (TW); Chaug-Liang Hsu, Taipei City (TW); Chih-Wei Tseng, Taipei County (TW)

Correspondence Address: HARNESS, DICKEY & PIERCE, P.L.C., P.O. BOX 8910, RESTON, VA, 20195, US

(21) Appl. No.: 11/252,571

(22) Filed: Oct. 19, 2005

(30) Foreign Application Priority Data
Nov. 12, 2004 (TW) 93134810

(51) Int. Cl. G01P 3/00

(52) U.S. Cl. 73/497

(57) ABSTRACT

An angular rate sensing device with temperature compensation and vibration compensation is provided. The device includes a base; a vibrator having multiple proof masses, arranged in the base; a plurality of flexible supporting members connected to the vibrator and supporting the vibrator to be suspended in the base; and a plurality of planar electrodes arranged relative to the proof masses, wherein each of the planar electrodes is connected to two signal lines with phase difference of 180 degree. The vibration error is compensated by way of connecting the signal lines, whose phase difference is of 0 degree, of the planar electrodes, whose position difference is of 180 degree; wherein the thermal expansion error is compensated by way of connecting the signal lines, whose phase difference is of 180 degree, of the planar electrodes, whose position difference is of 90 degree.

This Non-provisional application claims priority under 35 U.S.C. § 119(a) on Patent Application No(s). 093134810 filed in Taiwan, R.O.C. on Nov. 12, 2004, the entire contents of which are hereby incorporated by reference.

### BACKGROUND OF THE INVENTION

1. Field of Invention

The invention relates an angular rate sensing device and, in particular, to an angular rate sensing device having temperature compensation and vibration compensation.

2. Related Art

The gyroscope is a device that measures rotating angles or angular rates by using the inertia principle. One of these is a micro gyroscope manufactured by micro technology. It has been used widely in many fields, such as anti-overturning systems for cars, airbag systems, industrial robots, 3D mice, and Global Positioning Systems. The characteristics of small volume, light weight, and low cost have made micro gyroscopes, which are becoming potentially commercial sensors, penetrate the market of traditional gyroscopes.

Patents related to micro gyroscopes or micro angular rate sensors are disclosed, for example, in U.S. Pat. Nos. 5,450,751, 5,872,313, or 6,305,222.

Patent '751 discloses a microstructure for a vibratory gyroscope. The microstructure has a ring portion supported in such a fashion as to allow substantially undamped, high-Q radial vibration. The ring portion is electrically conductive and comprises a charge plate for a plurality of radially disposed charge conductive sites around its perimeter for sensing radial displacements thereof. The ring, its support and charge conductive sites are formed within sacrificial molds on one surface of a conventional silicon substrate, which may comprise a monolithic integrated circuit. The driving electrodes and sensing electrodes are provided in the peripheral of the ring. The driving electrodes drive the ring to oscillate parallel to the substrate. When an angular rate axially vertical to the substrate is inputted, the ring vibrates in oscillation mode with 45 degree difference. The sensing electrodes detect the distance variation between the electrodes and the ring. The temperature difference between the substrate and the ring, or the different thermal expansion coefficients and boundary conditions results in the relative position change of the substrate and the ring, and the distance between the substrate and the ring changes. Therefore, the detected capacitance changes accordingly, and the sensitivity varies with different temperature.

Patent '313 discloses a motion sensor having a micromachine sensing element and electrodes formed on a silicon chip. The sensing element includes a ring supported above a substrate so as to have an axis of rotation normal to the substrate. Surrounding the ring is at least one pair of diametrically-opposed electrode structures. The sensing ring and electrode structures are configured to include interdigitized members whose placement relative to one another enables at least partial cancellation of the differential thermal expansion effect of the ring and electrodes. The sensitivity variation is decreased by ways disclosed in '313 Patent under the situation that the affection of thermal expansion is far less than that of the distance. The errors are cancelled and the signals are amplified by means of sensing distance variation and differential circuits.

Patent '222 discloses a motion sensor including a micromachined sensing structure and a number of capacitive electrodes disposed about the periphery thereof. The sensing structure includes a ring supported above a substrate, and a number of springs attached to a post positioned at the center of the ring. Certain diametrically opposed capacitive electrodes are configured as drive electrodes, and other diametrically opposed capacitive electrodes, positioned 90 degrees relative to the corresponding drive electrodes, are configured as sense electrodes. The signals are inputted into the differential amplifier directly, and summing the radial signals to cancel the effects of linear forces due to road vibration.

The motion displacement is detected by capacitance change caused by the distance change between the electrodes in the prior art. However, the error of detected signal occurs due to the nonlinear, change of capacitance. Further, if the distance between the electrodes varies with the temperature or linear forces, then the sensitivity of the signal will decrease.

### SUMMARY OF THE INVENTION

In view of the foregoing problems, an angular rate sensing device having temperature compensation and vibration compensation is provided. Planar sensing structures and improved connection of signal lines are employed to substantially solve the foregoing problems and drawbacks of the related art.

According to the embodiment, the angular rate sensing device with temperature compensation and vibration compensation includes a base; a vibrator having multiple proof masses, arranged in the base; a plurality of flexible supporting members connected to the vibrator and supporting the vibrator to be suspended in the base; and a plurality of planar electrodes arranged relative to the proof masses for sensing motion of the proof masses relative to the planar electrodes through the capacitance variation between the planar electrodes and the proof masses. The planar electrodes are composed of two electrodes, each of which is connected to a signal line. The phase difference of the signals of the two signal lines is of 180 degree.

According to the embodiment, the vibration error of the angular rate sensing device is compensated by way of connecting the signal lines, whose phase difference is of 0 degree, of the planar electrodes, whose position difference is of 180 degree; wherein the thermal expansion error is compensated by way of connecting the signal lines, whose phase difference is of 180 degree, of the planar electrodes, whose position difference is of 90 degree.

According to the principle of the embodiment, the sensitivity of the angular rate sensing device may be uniform under different temperatures.

According to the principle of the embodiment, the coupling effect of the capacitance of the thermal expansion error cause by the temperature and the sensed capacitance is cancelled through the angular rate sensing device.

According to the principle of the embodiment, the sensitivity of the angular rate sensing device may be uniform under the affection of the linear force caused by vibration.

According to the principle of the embodiment, the coupling effect of the capacitance of the linear force error cause by the linear force and the sensed capacitance is cancelled through the angular rate sensing device.

According to the principle of the embodiment, the intensity of the sensed signals is increased through the angular rate sensing device.

It is to be understood that both the foregoing general description and the following detailed description are exemplary and are intended to provide explanation of the invention as claimed.

### BRIEF DESCRIPTION OF THE DRAWINGS

The accompanying drawings, which are included to provide a further understanding of the invention and constitute a part of this specification, illustrate embodiments of the invention and together with the description serve to explain the principles of the invention. In the drawings:

FIG. 1 is the schematic structure of the angular rate-sensing device in accordance with the invention;

FIG. 2 is the enlarged diagram of the A portion of the angular rate-sensing device in accordance with the invention in FIG. 1;

FIG. 3A is the schematic structure of another embodiment of the angular rate-sensing device in accordance with the invention;

FIG. 3B is the schematic structure of another embodiment of the angular rate-sensing device in accordance with the invention; and

FIG. 4 illustrates the arrangement of the proof masses and the planar electrodes.

### DETAILED DESCRIPTION OF THE INVENTION

Reference will now be made in detail to the embodiments of the invention, examples of which are illustrated in the accompanying drawings.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

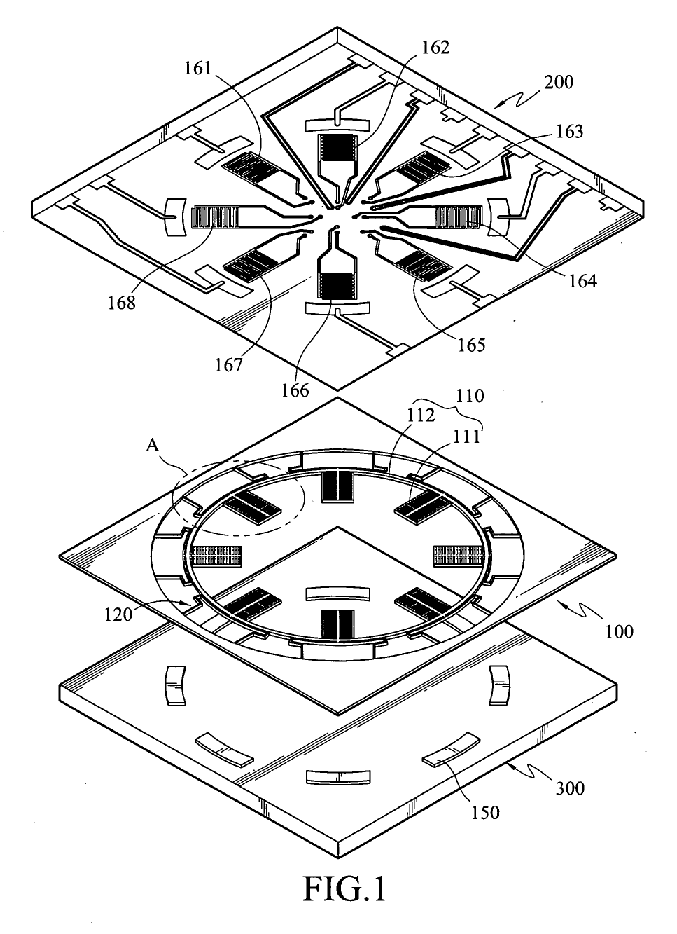

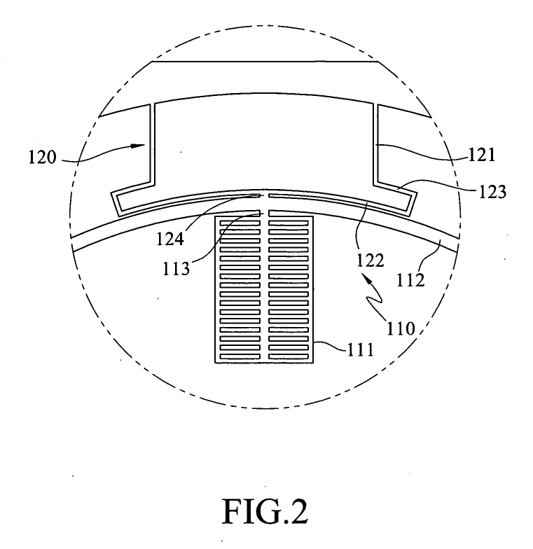

Refer FIG. 1 and FIG. 2. FIG. 1 the schematic structure of the angular rate sensing device in accordance with the invention, while FIG. 2 is the enlarged diagram of the A portion in FIG. 1.

The rate sensing device in accordance with the invention includes a first base, a second base, a third base 300, a vibrator with multiple proof masses 110, a plurality of flexible supporting member 120, a plurality of driving electrodes 150 and planar electrodes 161˜168. The vibrator 110 arranged on the first base 100 has a plurality of proof masses 111 and a ring 112. Each of the proof masses 111 is connected to the ring 112 of the vibrator 110 via a first connecting member 113. The flexible supporting member 120 is connected to the vibrator 110 to support the vibrator 110 in the first base 100 such that the vibrator 110 is suspended in the first base 100. In the embodiment, the proof mass 111 employs floating parallel electrodes with slots, and each is arranged corresponding to the planar electrodes 161˜168. The planar electrodes 161˜168 sense the capacitance variation caused by variation of the overlapping area between each of the planar electrodes 161˜168 and each of the proof masses 111. Therefore, the motion of the proof masses 111 is detected.

Each of the flexible supporting members 120 is composed of a flexible supporter set symmetrical to the driving axis or sensing axis of the vibrator 110 with multiple proof masses (or the ring 112). Each flexible supporting member 120 is equally arranged at the periphery of the ring 112 of the vibrator 110 with multiple proof masses. In one embodiment, there are eight flexible supporting members. The flexible supporter set has a pair of first supporters 121 and a second supporter 122. The first supporters 121 have a bending portion 123 for connecting the first supporters 121 and the second supporter 122. The second supporter 122 is connected to the vibrator 110 via a second connecting member 124 to keep a predetermined distance between the second supporter 122 and the vibrator 110 with multiple proof masses.

The first base 100 may be silicon-based material or glass, while the material of the vibrator 110 may adopts silicon-based material or metal. In one embodiment, the sensing electrodes relative to the float parallel electrodes and necessary control circuits may be arranged on the second base 200. In another embodiment, the electrodes 150 and the sensing electrodes and necessary control circuits for the electrodes and the sensing electrodes may also be arranged on the third base 300. The third base 300 may be silicon-based material or glass.

As illustrated in FIG. 1, the proof masses 111 are arranged at the interior periphery of the ring 112 of the vibrator 110, while the flexible supporting members 120 are arranged at the exterior periphery of the ring 112 of the vibrator 110.

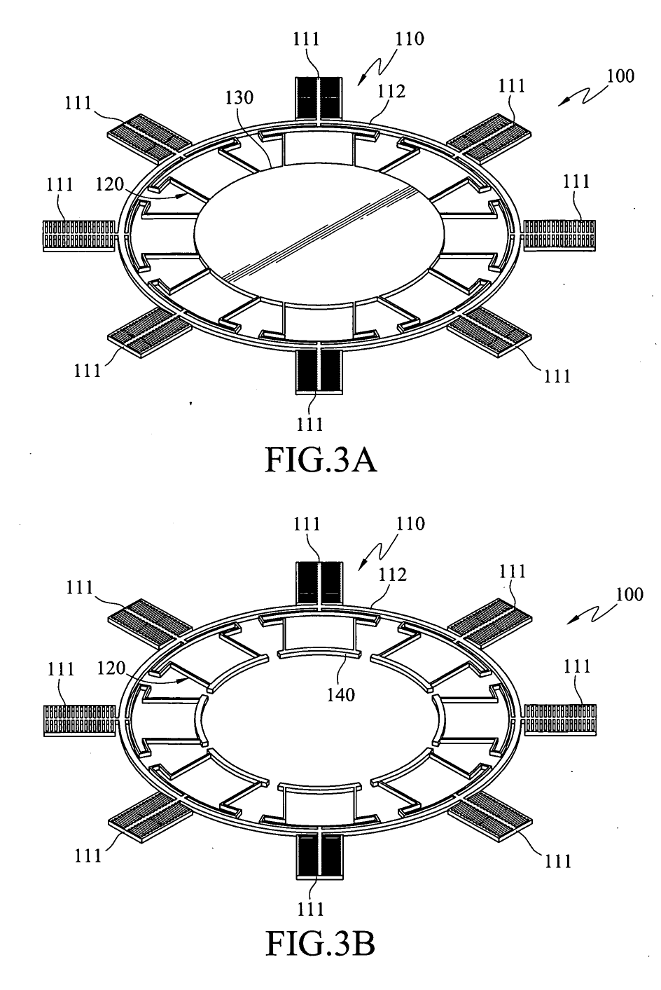

FIGS. 3A and 3B illustrate the schematic structure of another embodiment of the angular rate-sensing device in accordance with the invention. In this embodiment, the vibrator 110 is arranged at the exterior periphery of the ring 112 of the vibrator 110, while the flexible supporting members 120 are arranged at the interior periphery of the ring 112 of the vibrator 110. Also, a supporting anchor 130 (as shown in FIG. 3A) or a concentric ring base 140 is arranged in the central portion of the vibrator 110 to connect the flexible supporting members 120.

The driving electrodes 150 drive and control the proof masses 111 and the ring 112 to oscillate such that the oscillation mode of the vibrator in driving mode may be controlled.

In one embodiment, the driving electrodes 150 are radially arranged by pair on the third base 300. After bonding, each of the driving electrodes 150 is located within the corresponding flexible supporting member 120. In another exemplary embodiment, close loop control electrodes or compensation control electrodes are radially arranged by pair in the peripheral of the ring 112.

The proof masses 111 not only operate to increase the inertia mass of the ring 112 when oscillating, but also pair with the planar electrodes 161˜168 on the second base 200 as sensing electrodes for detecting the motion of the vibrator 110 ( or the ring 112) in driving mode and sensing mode. The planar electrodes 161˜168 and the proof masses are arranged correspondingly on the second base 200. The motion of the proof masses 111 relative to the planar electrodes 161˜168 is detected through the capacitance variation between the proof masses 111 and the planar electrodes 161˜168. The phase of the signals of the planar electrodes 161˜168 is connected inversely such that the area variation increases effectively. The planar electrodes 161˜168 connect to a sensing circuit (not shown) for receiving and summing the sensing signals of the sensing electrodes. The vibration error is compensated by way of connecting the signal lines, whose phase difference is of 0 degree, of the planar electrodes, whose position difference is of 180 degree; the thermal expansion error is compensated by way of connecting the signal lines, whose phase difference is of 180 degree, of the planar electrodes, whose position difference is of 90 degree.

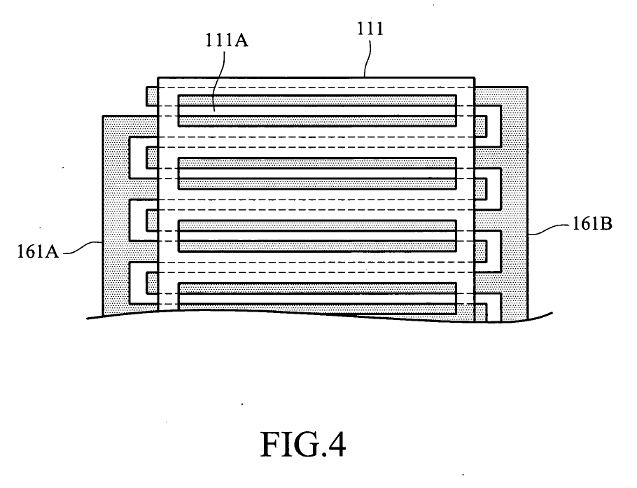

FIG. 4 illustrates the arrangement of the proof masses 111 and the planar electrodes. The planar electrode 161 is taken for illustration and the relative arrangement between the other proof masses 111 and the planar electrodes 162˜168 is the same/similar to that in FIG. 4.

The planar electrode 161 is composed of a first comb electrode 161A and a second comb electrode 161B. Each opening 111A of the proof mass 111 covers the first comb electrode 161A and the second comb electrode 161B when the ring 112 does not move. When the ring 112 moves due to external force, the overlapping areas of the first comb electrode 161A and the second comb electrode 161B covered by the openings 111A changes such that the capacitance between the openings 111A and the first comb electrode 161A and the second comb electrode 161B changes. The phase of the signals from the first comb electrode 161A and the second comb electrode 161B is connected inversely. The phase difference of the signals is substantially 180 degrees.

The linear error caused by vibration and the thermal expansion error caused by temperature variation are cancelled or compensated by way of summing the signals detected by each electrode. For the planar electrodes 161˜168, the vibration error is compensated by way of connecting the signal lines, whose phase difference is of 0 degree, of the planar electrodes, whose position difference is of 180 degree; the thermal expansion error is compensated by way of connecting the signal lines, whose phase difference is of 180 degree, of the planar electrodes, whose position difference is of 90 degree. The details are given in below.

The meanings of the symbols are defined as follows for convenience of discuss. C₀ is the initial capacitance. Δ C is the output value of the sensing capacitance. Δ Cs is the capacitance of the linear error caused by vibration. Δ Ct is the capacitance of the thermal expansion error caused by temperature variation.

The signal connections for one mode is illustrated for convenience of discuss. The other signal connection for the other mode is similar.

The first comb electrode 161A is arranged at the position of 0°, with the signal phase of 0°. The signal is C₀+ΔC+ΔCₛ+ΔCₜ.

The first comb electrode 163A is arranged at the position of 90°, with the signal phase of 0°. The signal is C₀ −ΔC+ΔCₜ.

The first comb electrode 165A is arranged at the position of 180°, with the signal phase of 0^{o}. The signal is C₀+ΔC−ΔCₛ+ΔCₜ.

The first comb electrode 167A is arranged at the position of 270°, with the signal phase of 0^{o}. The signal is C₀−ΔC+ΔCₜ.

The second comb electrode 161B is arranged at the position of 0°, with the signal phase of 180°. The signal is C₀−ΔC−ΔCₛ−ΔCₜ.

The second comb electrode 163B is arranged at the position of 90°, with the signal phase of 180°. The signal is C₀+ΔC−ΔCₜ.

The second comb electrode 165B is arranged at the position of 180°, with the signal phase of 180°. The signal is C₀−ΔC+ΔCₛ−ΔCₜ.

The second comb electrode 167B is arranged at the position of 270°, with the signal phase of 180°. The signal is C₀+ΔC−Cₜ.

The thermal expansion error is compensated by way of summing the signals whose phase difference is of 180 degree, of the planar electrodes, whose position difference is of 90 degree, for example, summing the signals of the first comb electrode 161A and the second comb electrode 163B, the first comb electrode 165A and the second comb electrode 167B, the first comb electrode 163A and the second comb electrode 165B, or the first comb electrode 167A and the second comb electrode 161B.

The vibration error is compensated by way of summing the signals whose phase difference is of 0 degree, of the planar electrodes, whose position difference is of 180 degree, for example, summing the signals of the first comb electrode 161A and the first comb electrode 165A, or the second comb electrode 161B and the second comb electrode 165B.

The thermal expansion error and vibration error is simultaneously cancelled by way of summing the signals of the first comb electrode 161A, the first comb electrode 165A, the second comb electrode 163B and the second comb electrode 167B. The summed signal is 4(C₀+ΔC). The thermal expansion error and vibration error is also simultaneously cancelled by way of summing the signals of the signals of the first comb electrode 163A, the first comb electrode 167A, the second comb electrode 161B and the second comb electrode 165B. The summed signal is 4(C₀−ΔC). An output signal 8 ΔC is thereby obtained by delivering the two summed signal 4(C₀+ΔC) and 4(C₀−ΔC) into a differential amplifier. Thus, it is apparent that the temperature therrmal expansion error and vibration error is simultaneously cancelled by way of the signal connection in accordance with the invention.

In the other mode, the signals are also summed by the same way, and an output signal 8 ΔC is thereby obtained. It is apparent that the thermal expansion error and vibration error is simultaneously cancelled.

In the other mode, the thermal expansion error and vibration error is simultaneously cancelled by way of summing the signals of the signals of the first comb electrode 162A, the first comb electrode 166A, the second comb electrode 164B and the second comb electrode 168B. The summed signal is 4(C₀+ΔC). The thermal expansion error and vibration error is also simultaneously cancelled by way of summing the signals of the signals of the first comb electrode 164A, the first comb electrode 168A, the second comb electrode 162B and the second comb electrode 166B. The summed signal is 4(C₀−ΔC). An output signal 8 ΔC is thereby obtained by delivering the two summed signal 4(C₀+ΔC) and 4(C₀−ΔC) into a differential amplifier. Thus, it is apparent that the thermal expansion error and vibration error is simultaneously cancelled by way of the signal connection in accordance with the invention.

The operation and principle of the compensation of the thermal expansion error and vibration error is given as follows. In the following illustration, W stands for the width of the sensing structure, L is the length of the overlap area between the sensing structure and the sensing electrode, d is the distance between the sensing structure and the sensing electrode, T is temperature of the structure, and F is linear force received by the structure.

For the slot type sensing structure, the temperature variation results in the coupling effect of the capacitance of the thermal expansion error cause by the temperature and the sensed capacitance. The signals, whose phase difference is of 180 degree, of the planar electrodes, whose position difference is of 90 degrees are summed such that the summing sensed areas under different temperature is equal

$$( \sum \frac{\partial L}{\partial T} \approx 0 ) .$$

Therefore, the sensed capacitance does not change with the temperature. Thus, the capacitance variation caused by the thermal expansion error is cancelled. The coupling effect of the capacitance of the thermal expansion error and the sensed capacitance is cancelled.

The linear force caused by vibration results in the coupling effect of the capacitance of the linear force error cause by the linear force and the sensed capacitance. The signals, whose phase difference is of 0 degree, of the planar electrodes, whose position difference is of 180 degree are summed such that the summing sensed areas under different linear force is equal

$$( \sum \frac{\partial L}{\partial F} \approx 0 ) .$$

Therefore, the sensed capacitance does not change with the linear force. Thus, the capacitance variation caused by the linear force error is cancelled. The coupling effect of the capacitance of the linear force and the sensed capacitance is cancelled.

The difference between the angular rate sensing device disclosed in the embodiments and the prior art is illustrated.

The meanings of the symbols are defined as follows for convenience of discuss. Cg is the capacitance of gap type structure while the gap between the two electrodes changed. Cp is the capacitance of slot type structure while the overlap area of the electrodes changed. The angular rate sensing device disclosed in the embodiments of the invention adopts the sensing electrodes of slot structure. The overlapping area variation between the sensing structure and the sensing electrodes is defined as the displacement of the device. The capacitance Cp and the displacement ΔL is linear relationship

$$( Cp = ɛ \frac{W ( L \pm Δ L )}{d} )$$

by means of slot structure, while the capacitance Cg and the displacement Δd is not linear relationship

$$( Cg = ɛ \frac{WL}{( d \pm Δ d )} )$$

by means of sensing distance variation. Under constant temperature, the amplification by means of slot structure is

$$\frac{\partial Cp}{\partial L} = ɛ \frac{W}{d} ,$$

while the amplification by means of sensing distance variation is

$$\frac{\partial Cg}{\partial d} = - ɛ \frac{WL}{{d}^{2}} .$$

The amplification by means of slot structure is constant, and does not vary with the temperature variation and the linear force

$$( \begin{matrix}\frac{\partial d}{\partial T} \approx 0 , & \frac{\partial W}{\partial T} \approx 0 , & \frac{\partial d}{\partial F} \approx 0 , & \frac{\partial W}{\partial F} \approx 0\end{matrix} ) .$$

The distance varies with the temperature variation and the linear force

$$( \begin{matrix}\frac{\partial d}{\partial T} \neq 0 , & \frac{\partial d}{\partial F} \neq 0\end{matrix} )$$

by means of sensing distance variation. Therefore, the signal amplification may remain the same under different temperature and linear force by means of slot structure. The sensitivity remains stable by using the sensing electrodes of slot structure.

Although the invention has been explained by the embodiments shown in the drawings described above, it should be understood to the person skilled in the art that the invention is not limited to these embodiments, but rather various changes or modifications thereof are possible without departing from the spirit and scope of the invention. Accordingly, the scope of the invention shall be determined only by the appended claims and their equivalents.

What is claimed is:

1. An angular rate sensing device with temperature compensation and vibration compensation comprising:
a base;
a vibrator having multiple proof masses, arranged in the base;
a plurality of flexible supporting members connected to the vibrator and supporting the vibrator to be suspended in the base; and
a plurality of planar electrodes arranged relative to the proof masses, wherein each of the planar electrodes is connected to two signal lines with phase difference of 180 degree, for sensing motion of the proof masses relative to the planar electrodes through the capacitance variation between the planar electrodes and the proof masses;
wherein the vibration error is compensated by way of connecting the signal lines, whose phase difference is of 0 degree, of the planar electrodes, whose position difference is of 180 degree; wherein the thermal expansion error is compensated by way of connecting the signal lines, whose phase difference is of 180 degree, of the planar electrodes, whose position difference is of 90 degree.

2. The device of claim 1, wherein each of the planar electrodes comprises a first comb electrode and a second comb electrode.

3. The device of claim 2, wherein the error caused by vibration and temperature variation is compensated by way of summing the signals of the first comb electrode arranged at 0 degree, the first comb electrode arranged at 180 degree, the second comb electrode arranged at 90 degree, and the second comb electrode arranged at 270 degree; wherein the error caused by vibration and temperature variation is compensated by way of summing the signals of the first comb electrode arranged at 90 degree, the first comb electrode arranged at 270 degree, the second comb electrode arranged at 0 degree, and the second comb electrode arranged at 180 degree.

4. The device of claim 2, wherein the error caused by vibration and temperature variation is compensated by way of summing the signals of the first comb electrode arranged at 45 degree, the first comb electrode arranged at 225 degree, the second comb electrode arranged at 135 degree, and the second comb electrode arranged at 315 degree; wherein the error caused by vibration and temperature variation is compensated by way of summing the signals of the first comb electrode arranged at 135 degree, the first comb electrode arranged at 315 degree, the second comb electrode arranged at 45 degree, and the second comb electrode arranged at 225 degree.

5. The device of claim 1 further comprises a sensing circuit connected to the signals of the planar electrodes, for receiving the sensing signals of the planar electrodes, and summing and differentially amplifying all the sensing signals of the planar electrodes.

6. The device of claim 1, wherein the vibrator comprises a ring and a plurality of proof masses.

7. The device of claim 6 further comprises a first connecting member connects each of the proof masses to the ring.

8. The device of claim 6, wherein the proof masses are floating parallel electrodes.

9. The device of claim 8, wherein the electrodes are slot type floating parallel electrodes, which are configured in differential circuits.

10. The device of claim 1, wherein the plurality of flexible supporting members comprises elements symmetrical to the driving axis or sensing axis of the vibrator, and are equally arranged at the periphery of the vibrator.

11. The device of claim 10, wherein the flexible supporting member comprises a flexible supporter set comprising:
a pair of first supporters; and
a second supporter connected to the pair of the first supporters.

12. The device of claim 11, wherein each of the pair of the first supporters further comprises a bending portion connecting the pair of the first supporters and the second supporter.

13. The device of claim 11, wherein the flexible supporting member further comprises a second connecting member connecting the second supporter and the vibrator to keep a predetermined distance between the second supporter and the vibrator.

14. The device of claim 1, wherein the flexible supporting members are arranged at the interior periphery of the vibrator, and the proof mass is arranged at the exterior periphery of the vibrator.

15. The device of claim 1, wherein the flexible supporting members are arranged at the exterior periphery of the vibrator, and the proof mass is arranged at the interior periphery of the vibrator.

16. The device of claim 15 further comprises an anchor or a concentric ring base arranged in the central portion of the vibrator to connect the flexible supporting members.

17. The device of claim 1, wherein the material of the base is silicon-based material or glass, and that of the vibrator is silicon-based material or metal.

18. An angular rate sensing device with temperature compensation and vibration compensation comprising:
a first base and a second base;
a vibrator having multiple proof masses, arranged in the first base, wherein the proof masses are connected to the vibrator;
a plurality of flexible supporting members connected to the vibrator and supporting the vibrator to be suspended in the first base;
a plurality of electrodes for driving and controlling the flexible supporting members to oscillate such that the oscillation mode of the vibrator in driving mode may be controlled; and
a plurality of planar electrodes arranged relative to the proof masses, wherein each of the planar electrodes is connected to two signal lines with phase difference of 180 degree, for sensing motion of the proof masses relative to the planar electrodes through the capacitance variation between the planar electrodes and the proof masses;
wherein the vibration error is compensated by way of connecting the signal lines, whose phase difference is of 0 degree, of the planar electrodes, whose position difference is of 180 degree; wherein the thermal expansion error is compensated by way of connecting the signal lines, whose phase difference is of 180 degree, of the planar electrodes, whose position difference is of 90 degree.

19. The device of claim 18, wherein each of the planar electrodes comprises a first comb electrode and a second comb electrode.

20. The device of claim 19, wherein the error caused by vibration and temperature variation is compensated by way of summing the signals of the first comb electrode arranged at 0 degree, the first comb electrode arranged at 180 degree, the second comb electrode arranged at 90 degree, and the second comb electrode arranged at 270 degree; wherein the error caused by vibration and temperature variation is compensated by way of summing the signals of the first comb electrode arranged at 90 degree, the first comb electrode arranged at 270 degree, the second comb electrode arranged at 0 degree, and the second comb electrode arranged at 180 degree.

21. The device of claim 19, wherein the error caused by vibration and temperature variation is compensated by way of summing the signals of the first comb electrode arranged at 45 degree, the first comb electrode arranged at 225 degree, the second comb electrode arranged at 135 degree, and the second comb electrode arranged at 315 degree; wherein the error caused by vibration and temperature variation is compensated by way of summing the signals of the first comb electrode arranged at 135 degree, the first comb electrode arranged at 315 degree, the second comb electrode arranged at 45 degree, and the second comb electrode arranged at 225 degree.

22. The device of claim 18 further comprises a sensing circuit connected to the signals of the planar electrodes, for receiving the sensing signals of the planar electrodes, and summing and differentially amplifying all the sensing signals of the planar electrodes.

23. The device of claim 18, wherein the vibrator comprises a ring and a plurality of proof masses.

24. The device of claim 23 further comprises a first connecting member connects each of the proof masses to the ring.

25. The device of claim 23, wherein the proof masses are floating parallel electrodes.

26. The device of claim 25, wherein the electrodes are slot type floating parallel electrodes, which are configured in differential circuits.

27. The device of claim 18, wherein the plurality of flexible supporting members comprises elements symmetrical to the driving axis or sensing axis of the vibrator, and are equally arranged at the periphery of the vibrator.

28. The device of claim 27, wherein the flexible supporting member comprises a flexible supporter set comprising:
a pair of first supporters; and
a second supporter connected to the pair of the first supporters.

29. The device of claim 28, wherein each of the pair of the first supporters further comprises a bending portion connecting the pair of the first supporters and the second supporter.

30. The device of claim 18, wherein the flexible supporting member further comprises a second connecting member connecting the second supporter and the vibrator to keep a predetermined distance between the second supporter and the vibrator.

31. The device of claim 18, wherein the flexible supporting members are arranged at the interior periphery of the vibrator, and the proof mass is arranged at the exterior periphery of the vibrator.

32. The device of claim 18, wherein the flexible supporting members are arranged at the exterior periphery of the vibrator, and the proof mass is arranged at the interior periphery of the vibrator.

33. The device of claim 32 further comprises an anchor or a concentric ring base arranged in the central portion of the vibrator to connect the flexible supporting members.

34. The device of claim 18, wherein each of the electrodes is arranged on a third base, each is in each of the flexible supporting member, wherein the first base and the third base are boned together such that the vibrator suspense in the first base and the third base.

35. The device of claim 18, wherein the second base is provided with the planar electrodes corresponding to the proof masses of the floating parallel electrodes and the control circuits, wherein the first base, the second base and the third base are boned together, and the material of the third base is silicon-based material or glass.

36. The device of claim 18 further comprises a third base provided with control circuits for the driving electrodes and the sensing electrodes, wherein the first base, the second base and the third base are boned together, and the material of the third base is silicon-based material or glass.

37. The device of claim 18, wherein the material of the base is silicon-based material or glass, and that of the vibrator is silicon-based material or metal.
